(19) United States
(12) Patent Application Publication
(10) Pub. No.: US 2008/0003870 A1
(43) Pub. Date: Jan. 3, 2008

(54) PROCESS FOR THE PREPARATION OF EXTRUDED THERMOPLASTIC BOARDS HAVING ENHANCED MECHANICAL STRENGTH

(75) Inventors: Phillip Wu, Victoria, TX (US); Yao Cheng, Port Lavaca, TX (US); Haur-Horng Yang, Victoria, TX (US)

Correspondence Address: SENNIGER POWERS, ONE METROPOLITAN SQUARE, 16TH FLOOR, ST LOUIS, MO, 63102, US

(73) Assignee: Inteplast Group, Ltd., Livingston, NJ (US)

(21) Appl. No.: 11/765,111

(22) Filed: Jun. 19, 2007

Related U.S. Application Data
(60) Provisional application No. 60/806,390, filed on Jun. 30, 2006.

(51) Int. Cl. H01R 13/60

(52) U.S. Cl. 439/567

(57) ABSTRACT

The present invention generally relates to an extruded thermoplastic board having a light weight relative to its thickness, as well as enhanced mechanical strength relative to its weight. More specifically, the present invention relates to an extruded, thermoplastic board that is corrugated (e.g., a board containing internal ribs), that is both thick and light weight, and that has enhanced mechanical strength. The present invention is additionally directed to a process for preparing such a board.

### CROSS REFERENCE TO RELATED APPLICATION

This application claims priority from U.S. provisional application Ser. No. 60/806,390, filed on Jun. 30, 2006.

### FIELD OF THE INVENTION

The present invention generally relates to an extruded thermoplastic board having a light weight relative to its thickness, as well as enhanced mechanical strength relative to its weight. More specifically, the present invention relates to an extruded, thermoplastic board that is corrugated (e.g., a board containing internal ribs), that is both thick and light weight, and that has enhanced mechanical strength. The present invention is additionally directed to a process for preparing such a board.

### BACKGROUND OF THE INVENTION

Thermoplastic panels or boards, and more particularly corrugated thermoplastic boards, which are made of thermoplastic resin, are widely known and used in a number of applications, including for sign, lamination and graphic art applications. Processes for their production are generally known to those skilled in the art.

U.S. Pat. Nos. 3,509,005; 3,664,906; 3,748,217; and 3,741,857 disclose a method for the manufacture of such a lightweight board by integrally molding a sheet with a plurality of ribs extending from the surface of the sheet. Another sheet of plain structure or having a plurality of extending ribs from the surface of the sheet can be bonded to the previous sheet by bringing the two sheets together under heat-softened conditions such that the two sheets heat bond to one another.

U.S. Pat. Nos. 5,910,226 and 3,837,973 disclose a method for the manufacture of thermoplastic boards, which consists of two or three extruders. The material from the middle extruder is molded into shapes by a roller and is united with the films from the other two extruders into one member by fusing together while they are under heat-softened conditions. A pressure is applied when the sheets are united together by fusion state connection at their mutually contacting parts in the previous techniques. The thermoplastic sheeting produced according to the previous techniques has a plurality of ridges arising from the flat sheet along the contacting lines of the flat sheets and ribs, which significantly affects the flatness of the surfaces.

U.S. Pat. Nos. 3,274,315; 3,792,951; 4,513,048; and 5,658,644 disclose a process which integrally extrude the two sheets and the plurality of the ribs of the thermoplastic board through an extrusion orifice having a corresponding orifice configuration. The extruded boards then enter a calibrator, which cools and shapes the dimension of the board. The boards manufactured by such method consist of a pair of sheets or layers spaced apart and interconnected by longitudinally extending ribs so that the interior of the boards contains a plurality of extending straight passageways.

U.S. Pat. No. 6,759,114 discloses a process for forming a thermoplastic board having enhanced surface smoothness. Plastic lightweight boards may exhibit a plurality of depression bands, which negatively affect surface flatness. The depression bands are especially apparent for polymers of high crystallinity such as polypropylene, high-density polyethylene, etc. It is believed that the depression bands are due to the thermal contraction and crystallization of the polymeric material in the extending ribs. In the method described by U.S. Pat. No. 6,759,114, the core section of the board is co-extruded with a blowing agent that decomposes at elevated temperatures. The addition of a blowing agent expands the rib section to compensate for the shrinkage of the rib sections due to thermal contraction and the crystallization of the thermoplastic material when it cools after exiting the extrusion die. Consequently, the depths of the depression bands on the surfaces of the thermoplastic boards are reduced and the surface smoothness is substantially enhanced.

All of the above-noted patents are incorporated herein by reference for all relevant purposes.

### SUMMARY OF THE INVENTION

Briefly, therefore, the present invention is directed to a thermoplastic polyolefin board comprising a first outwardly facing surface, and a second outwardly facing surface, wherein said first and second outwardly facing surfaces are about parallel to each other, and further wherein the board has a thickness, as measured by a distance between the first outwardly facing surface and the second outwardly facing surface, of at least about 15 mm and a weight of at least about 2,000 g/m².

The present invention is further directed to such a thermoplastic board, wherein said board has a weight of less than about 12,000 grams per square meter of surface area.

The present invention is still further directed to one or both of the above-noted boards, which can sustain a loading pressure of at least about 50 pounds per square foot (e.g., about 60, about 70, about 80, about 90, about 100 or more, up to about 105 lbs/ft²).

The present invention is further directed to a thermoplastic polyolefin board comprising a first outwardly facing surface, a second outwardly facing surface, wherein the first outwardly facing surface and the second outwardly facing surface are about parallel to each other, and further wherein the thermoplastic, polyolefin board has a thickness, as measured by a distance between the first outwardly facing surface and the second outwardly facing surface, of at least about 16 mm and can sustain a loading pressure of at least about 70 lb/ft².

The present invention is still further direct to one or more of the above-noted boards, wherein said board is corrugated; that is, wherein said board comprises a first planar sheet having an outwardly facing surface and an inwardly facing surface, a second planar sheet having a outwardly facing surface and an inwardly facing surface, said first and second planar sheets being about parallel to each other, and being spaced apart and connected by a plurality of ribs extending between and contacting the inwardly facing surfaces of the first and second planar sheets.

The present invention is still further directed to an extrusion method of preparing one or more of the above-noted. In one particular embodiment, said extrusion method comprises the steps of: (a) extruding a thermoplastic resin through a die to form a board comprising (i) a first planar sheet having an outwardly facing surface and an inwardly facing surface, (ii) a second planar sheet having a outwardly facing surface and an inwardly facing surface, said first and second planar sheets being disposed in about parallel spaced relationship to each other, and (iii) a plurality of ribs extending between the first and second planar sheets, each of said ribs having connecting points to said inwardly facing surfaces of said first planar sheet and said second planar sheet, and forming, in combination with said sheets, a plurality of elongated lateral passageways; (b) injecting air into passageways in the extruded board, as said passageways are formed; (c) vacuum shaping and cooling the extruded thermoplastic board, and, (d) cutting the cooled board into sections of desired length, wherein said board has a thickness, as measured by a distance between the first outwardly facing surface and the second outwardly facing surface, of at least about 15 mm.

The present invention is still further directed to such a process which additionally comprising controlling shrinkage of the extruded board after exiting the die and before being subjected to vacuum shaping and further cooling, such that the thickness of the extruded board decreases by less than about 5% and/or the width of the extruded board decreases by less than about 3%, as determined by comparing the thickness or width of the board as it exits the die to the thickness or width of the board just prior to being subjected to shaping and further cooling.

Other objects and features of the invention will be in part apparent and in part pointed out herein.

### BRIEF DESCRIPTION OF THE FIGURES

FIG. 1 is a perspective view of parts of an embodiment of the thermoplastic board of the present invention, consisting of a pair of sheets or layers, which are spaced apart and interconnected by ribs extending therebetween.

FIG. 2 is a sectional view of another embodiment of a thermoplastic board.

FIG. 3 is a sectional view of another embodiment of a thermoplastic board.

FIG. 4 is a sectional view of another embodiment of a thermoplastic board.

FIG. 5 is a schematic drawing of an embodiment of a process for the production of a thermoplastic board of the present invention.

FIG. 6A is a sectional view of part of a die which produces a thermoplastic board of the present invention, which comprises a pair of sheets or layers that are generally flat and substantially parallel to each other, and spaced apart and interconnected by extending ribs, which are substantially vertical to the two sheets.

FIG. 6B is a cross-sectional view of part of the die in FIG. 6A, which produces a thermoplastic board of the present invention. The cross-sectional view of 6B is perpendicular to the sectional view presented in FIG. 6A, the cross-section being make approximately through the center of a mandrel and bore illustrated in FIG. 6A.

FIG. 7 is a sectional view of another embodiment of a thermoplastic board, which may be particularly well-suited for boards having thickness in excess of, for example, about 20 mm (e.g., about 25 mm, about 30 mm or more), due to the presence of one set of ribs that extend perpendicular from the first and second horizontal sheets, and a second set of ribs that extend horizontally between the perpendicular ribs.

### DETAILED DESCRIPTION OF THE PREFERRED EMBODIMENTS

The present invention is generally directed to an extruded thermoplastic board having a light weight relative to its thickness, as well as enhanced mechanical strength relative to its weight. More specifically, the present invention relates to an extruded, thermoplastic board that is corrugated (e.g., a board containing internal ribs), that is both thick and light weight, and that has enhanced mechanical strength. Such boards may be useful in a number of applications, including for example as construction materials (e.g., doors, window shutters, storm panels, etc.), and/or as sign boards. The present invention is additionally directed to a process for preparing such a board, particularly an integrated coextrusion process, which is advantageous over conventional processes wherein boards, or pieces of boards, are laminated or glued together; that is, the present invention is directed to a process for preparing a single-piece board formed by an integrated coextrusion process, rather than an process using lamination and/or gluing of multiple boards or board pieces together.

A. The Thermoplastic Board

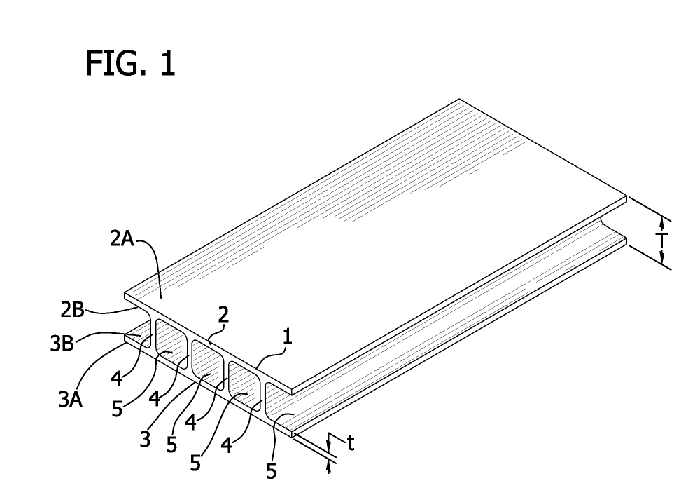

Referring now to FIG. 1, one embodiment of a board of the present invention is illustrated, the board having a corrugated structure. More specifically, the board (1) consists of a first planar sheet (2) and a second planar sheet (3), which is about parallel to the first planar sheet. Both of the first and second sheets have an outwardly facing surface (2A and 3A, respectively) and an inwardly facing surface (2B and 3B, respectively), the inwardly facing surfaces of sheets (2) and (3) being connected (e.g., integrally interconnected) by a core comprising a plurality of longitudinal extending ribs (4), which may have any number of shapes or configurations. Within the sheeting, the combination of the inwardly facing surfaces of the sheets (2) and (3) and the adjacent surfaces of a pair of ribs (4) define elongated and generally rectangular passageways (5). These passageways may be alternatively referred to as ducts or flutes.

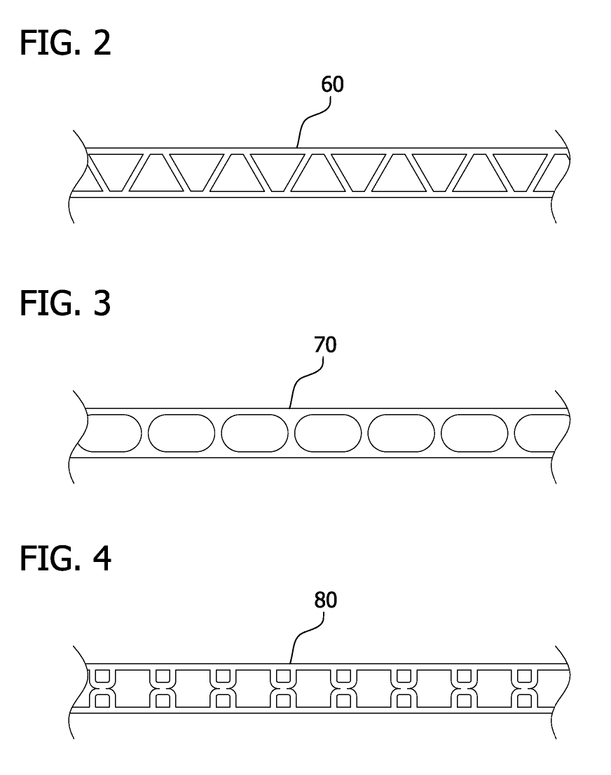

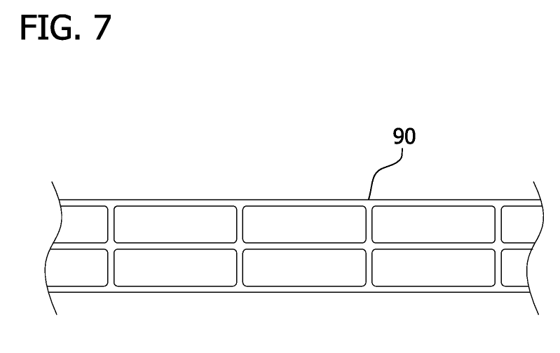

Although the thermoplastic board in FIG. 1, which contains two generally planar sheets spaced apart and interconnected by ribs extending generally perpendicular to said sheets is used as an illustration of the present invention, it is to be noted that numerous modifications and variations of the configuration of the boards are possible in light of this disclosure, and thus do not depart from the scope of the present invention. For example, FIGS. 2 through 4 and 7 illustrate additional embodiments of thermoplastic boards (60), (70), (80) and (90), respectively, which can be made by the present invention. These drawings show sectional views of parts of several types of corrugated thermoplastic boards, which can be made by the present invention. The examples in FIGS. 2 through 4 and 7 are illustrative of types of thermoplastic board configurations that can be made by the process of present invention. Accordingly, the configurations provided here are intended to be exemplary, and thus are not intended as a limitation of the scope of the present invention.

Referring again to FIG. 1, the board of the present invention is relatively thick, as compared to thermoplastic boards of this type known in the art. The thickness, T, of the board is measured from the outwardly facing surface of the first planar sheet to the outwardly facing surface of the second planar sheet. In one embodiment, the board has a nominal thickness of at least about 10 mm thick, at least about 13 mm thick, at least about 15 mm thick, at least about 16 mm thick, at least about 20 mm thick or more (e.g., at thickness of about 25 mm, about 30 mm or more). Additionally, or alternatively, due for example to processing limitations and/or other considerations, the board may have a nominal thickness of less than about 30 mm, or about 25 mm. Accordingly, boards of the present may, for example, have a nominal thickness falling within the range of about 10 or about 15 mm thick to about 30 mm thick, or about 15 mm to about 25 mm thick, or about 15 to about 20 mm thick. Exemplary board thicknesses that may have particular commercial applicability include about 15 mm, about 16 mm, about 17 mm, about 18 mm, about 19 mm, or even about 20 mm.

As illustrated in FIG. 1, the board of the present invention may comprise a number of ribs extending between the two sheets (e.g., top and bottom sheets) of the board. The number of ribs, as well as the configuration or design (e.g., the ribs, in combination with the sheets, forming generally square, rectangular, trapezoidal (60), triangular, oval (70), circular, semi-circular, etc., passageways through the internal portion of the board, which may be of uniform size or varying size (80) as illustrated for example in FIGS. 1 through 4), may vary for a given application, the number and or design being optimized in order, for example, to maximize the strength of the board relative to the weight thereof. Additionally, the thickness of the ribs, or more generally the connections between the sheets, may also be optimized for a given application or use. For example, the ribs may generally have a nominal thickness of from about 0.1 mm to about 5.0 mm, or about 0.3 mm to about 3.0 mm. Additionally, in these or other embodiments, the number of ribs per foot of cross-sectional width of the board may also be within the range of, for example, about 10 to about 100, or about 15 to about 80, or about 20 to about 60, or about 25 to about 50.

In this regard, it is to be noted that the ribs, in combination with the first and second sheets, form ducts or flutes, which define or surround a void volume. For example, in one embodiment, a board having a plurality of ducts and having a thickness of at least about 15 mm may have a void volume compared to the total volume of the board of between about 50% and about 95%, or between about 65% and about 85%.

Additionally, in these or still other embodiments, the nominal thickness, t, of the sheets themselves (as determined by measuring the distance between the outwardly facing surface and the inwardly facing surface) may also vary for the same reasons. For example, this nominal thickness may range from about 0.1 mm to about 5.0 mm, or about 0.3 mm to about 3.0 mm. In these or still other embodiments, the ratio of the thickness of a sheet (i.e., the nominal thickness of the first or second sheet) to the nominal thickness of the ribs may be within the range of about 0.2 to about 4, or about 0.3 to about 3, or about 0.4 to about 2, or about 0.5 to about 1.5.

As illustrated in FIGS. 1 through 4, a board of the present invention may be constructed by combining three components: a first planar sheet (2), a second planar sheet (3), and a core comprising a plurality of ribs (4) extending longitudinally from one of the sheets to the other. A board may be constructed according to a variety of weight specifications for each respective component. For example, in one embodiment, the first planar sheet and the second planar sheet may make up between about 10 wt. % and about 50 wt. %, or between about 20 wt. % and about 40 wt. %, of the total board weight; stated another way, the core comprising the plurality of ribs may makes up between about 50 wt. % and about 90 wt. %, or between about 60 wt. % and about 80 wt. %, of the total board weight. In one embodiment, the relative weight percentages for the first planar sheet, core, and second planar sheet are between about 10 wt. %, about 80 wt. % and about 10 wt. %, respectively, to about 25 wt. %, about 50 wt. % and about 25 wt. %, respectively. In one particular embodiment, the relative weight percentages for the first planar sheet, core, and second planar sheet are about 15 wt. %, about 70 wt. % and about 15 wt. %, respectively.

Despite having a relatively high thickness, a board of the present invention is light weight relative to that thickness. For example, a conventional method to indicate the weight of the board is to divide the mass of the board by the surface area in square meters of either of the planar sheets which make up the exterior of the board. This measurement, having units of grams per square meters (g/m²), is what is meant by “weight” of the board throughout this disclosure. A board of the present invention having relatively low weight typically has a weight no greater than about 12,000 g/m². Preferably, the weight is no greater than about 8,000 g/m². A board of the present invention also typically has a minimum weight that may be as low as about 2,000 g/m². More typically, the minimum weight is greater than about 3,000 g/m², or about 3,500 g/m². Accordingly, in one embodiment, the weight of the board is between about 2,000 g/m² and about 12,000 g/m², or between about 3,000 g/m² and about 8,000 g/m², or between about 3,000 g/m² and about 4,500 g/m², or between about 3,500 g/m² and about 5,000 g/m². However, it is to be noted that the weight may be dictated by the application. For example, when the board is used as a storm panel, the weight may be between about 3,000 g/m² and about 3,300 g/m².

As previously noted, a board of the present invention has a relatively low weight compared to its thickness. For example, in one embodiment a board having a thickness as set forth elsewhere herein (e.g., about 15 mm, about 16 mm, about 17 mm, about 18 mm, about 19 mm, about 20 mm or more) may have a weight between about 3,000 g/m² and about 4,500 g/m². Accordingly, a ratio of the weight (in g/m²) to total thickness (in mm) for a board having such a thickness may range from about 100:1 to about 500:1, or about 150:1 to about 300:1 (e.g., less than about 275:1, about 250:1, about 225:1, or even about 200:1), such as between about 175:1 and about 225:1, or between about 180:1 and about 220:1. The achievement of these weight to thickness ratios is unexpected because conventional methods of producing thicker boards typically require an increase of material added to the plurality of connecting ribs in response to “necking.” Necking describes the tendency of the board material to shrink after the board leaves the die and cools. Necking causes distortions in the board such that they do not have flat, planar surfaces. One method for decreasing “necking” is the addition of material to the connecting ribs (i.e., the core section of the board). Adding material to the core may inhibit necking, but this method of solving the problem is not advantageous from a cost perspective (i.e., the addition of material increases the costs of producing the boards). Additionally, some applications which may require a thicker board, such as those applications wherein lamination is typically used to prepare a board suitable for use, may be better suited toward having relatively lighter weight boards than conventional processes can provide.

Accordingly, in one embodiment, a board having a thickness of at about 15 mm may have a ratio of weight (in g/m²) to total thickness (in mm) between about 100 and about 300. In another embodiment, a board having a thickness of at least 16 mm may have a ratio of weight in g/m² to total thickness between about 125 and about 250. In yet another embodiment, a board having a thickness of at about 17 mm may have a ratio of weight in g/m² to total thickness between about 150 and about 300. In yet another embodiment, a board having a thickness of at about 19 mm may have a ratio of weight in g/m² to total thickness between about 175 and about 350.

The board of the present invention also has enhanced mechanical strength relative to its weight. A method of measuring the mechanical strength is by the ASTM E1996 compliance test. ASTM E1996 is a standard specification for performance of exterior windows, curtain walls, doors, and impact protective systems impacted by windborne debris in Hurricanes. In ASTM E1996, missiles of wood lumber are shot at the specimens with high speed to test the impact protection of materials. Additionally, air pressures are applied on specimens to test the load strength of specimen. A board of the present invention, which for example may be about 16 mm in thickness, about 4 feet in length, about 5 feet in width, about 3,300 g/m² in base weight, and contains at least about 90% polyolefin (as further detailed herein below), was observed to pass the ASTM E1996 wind zone 4 (highest level) test, having a sustained pressure loading of at least about 50 lbf/ft² (e.g., at least about 60 lbf/ft², at least about 70 lbf/ft², at least about 80 lbf/ft², at least about 90 lbf/ft², or at least about 100 lbf/ft²), and a pressure loading up to about 105 lbf/ft². The board of the present invention is believed to be the first thermoplastic board comprised of a thermoplastic (e.g., polyolefin) material produced by integrated extrusion that passed the ASTM E1996 wind zone 4 test. Therefore, the board may be widely used in a variety of applications, such as doors, window shutters, sign boards, etc., in hurricane areas.

As noted above, the board of the present invention comprises a thermoplastic polymer. Suitable thermoplastic materials may generally include those known in the art, including for example polyolefins (such as linear or branched polypropylenes and linear or branched polyethylenes, as well as copolymers comprising one or more thereof, which are generally known in the art for this type of application); linear or branched polystyrenes and linear or branched styrene copolymers of various kinds, which are generally known in the art for this type of application; halo-substituted vinyl polymers, such linear or branched polyvinyl chlorides and linear or branched copolymers thereof, which are generally known in the art for this type of application; linear or branched polymers prepared from acrylic resins; polycarbonates; polyethylene terephthalates and copolymers thereof, which are generally known in the art for this type of application; and so on, including mixtures (e.g., random or block copolymers) thereof. In one particular embodiment, the thermoplastic material is a polyolefin, such as a linear or branched polypropylene or a linear or branched polyethylene, as well as random or block copolymers comprising one or more thereof, which are generally known in the art for this type of application. In one embodiment, the board comprises at least about 50 wt. % of the thermoplastic material. In one preferred embodiment, the board comprises at least about 70 wt. %, about 80 wt. %, about 90 wt. %, about 95 wt. %, or even about 100 wt. %, of a thermoplastic polyolefin, such as those noted herein and/or generally known in the art.

In this regard it is to be noted that the board of the present invention may optionally comprise a thermoplastic material that is also elastic (i.e., a thermoplastic elastomer). Such polymers may include thermoplastic, elastomeric polyolefins, such as an elastic polyethylene polymer (e.g., an elastic polyethylene polymer sold under the trade name AFFINITY™ available from Dow Chemical).

In this regard it is to be noted that the choice of thermoplastic may depend on the application for which the board is intended. For example, a preferred thermoplastic material for use as a storm panel or lamination substrate is polypropylene sold under the trade name Formolene® PP (commercially available from Formosa Plastic Corporation, USA). In another embodiment, a preferred thermoplastic material for use as a storm panel or vehicle bottom board is linear or branched polyethylene sold under the trade name Formolene® PE (commercially available from Formosa Plastic Corporation, USA).

The concentration of the polymer(s) in the board, or the mixture to be extruded to form the board, may vary, depending for example on the particular use. Typically, however, the total polymer concentration is greater than about 50 wt. %, about 60 wt. %, about 70 wt. %, or about 80 wt. %, and may be about 85 wt. %, about 90 wt. %, about 95 wt. % or more, the concentration for example ranging from about 50 wt. %, about 60 wt. %, or about 70 wt. % to about 100 wt. %, or about 80 wt. % to about 97 wt. %, or about 90 wt. % and about 95 wt. %. Additionally, when a copolymer is used, the ratio of one polymer to the other may also be optimized for the particular use. Typically, however, the ratio will range from greater than about 1:1 to less than about 20:1, or greater than about 5:1 to less than about 15:1, or greater than about 8:1 to less than about 12:1. Thus, in one exemplary embodiment, the board may comprise about 94 wt. % polymer, such polypropylene. In another exemplary embodiment, the board may comprise about 94 wt. % polymer, which may be for example about 88 wt. % polypropylene and about 6 wt. % polyethylene. In yet another exemplary embodiment, the board may comprise about 93 wt. % polymer, which may be for example about 87 wt. % polypropylene and about 6 wt. % polyethylene.

Although the composition of a board may be uniform among the first planar sheet (2), the second planar sheet (3), and the core comprising a plurality of longitudinal extending ribs (4), in some embodiments, the compositions of the sheets and the core may differ, or the compositions of the first sheet, second sheet, and the core may all differ. For example, in one embodiment, the first and second planar sheets comprise about 94 wt. % polymer, such as polypropylene, and the core layer comprising the extending ribs comprises about 100 wt. % polymer, which may be for example about 80 wt. % polypropylene and about 20 wt. % elastic polymer. In another embodiment, the first and second planar sheets comprise about 94 wt. % polymer, such as polypropylene, and the core layer comprising the extending ribs comprises about 99 wt. % polymer, such as polypropylene.

It is to be noted that, optionally, the composition of the thermoplastic material, such as for the rib section, may include a blowing or foaming agent. In those embodiments where a blowing agent or foaming agent is included, the hopper containing the thermoplastic material, such as the hopper containing the material for the rib section, of the extruded material itself (e.g., the rib section after extrusion, forming and cooling are complete) may include between about 0.01 wt. % and about 5 wt. %, or between about 0.5 wt. % and about 3 wt. %, or between about 1 wt. % and about 2 wt. %, blowing agent, which decomposes at the elevated temperatures used for processing. The proportion of the blowing agent in the composition of the thermoplastic material may be adjusted according to various considerations generally known in the art (e.g., the gas yield per unit weight of the blowing agent, the thermoplastic material, the extrusion devices, etc.).

Essentially any commonly used organic or inorganic blowing agent that decomposes when heated to the temperature level commonly used for thermoplastic extrusion can be used in this invention. The organic blowing agents that can be used include, for example: azodicarbonamide; N,N′-dinitrosopentamethylene tetramine; N,N′-dinitroso-N-N′-dimethyl terephthal amide; benzene sulfonyl hydrazide; benzene-1,3-disulfohydrazide; terephthalic azide; and the like. The inorganic blowing agents that can be used include, for example: sodium bicarbonate; ammonium chloride; and the like. The blowing agents, either organic or inorganic, can be used alone or in combination with other blowing agents in the present invention. High-pressure gases, such as carbon dioxide, nitrogen, etc., can also be used as blowing agents in light of the teaching provided herein, and generally known in the art.

Additional ingredients, which are usually used as additives in the thermoplastic material, can be appropriately selected and employed if desired in the present invention, in view of the various considerations generally recognized in the art (e.g., optimization of board strength, weight, etc.). Such ingredients may include, for example, fillers, such as glass fibers, talc, calcium carbonate, etc., which are usually used in plastic material to reinforce the mechanical properties. In addition, colorants, antistatic agents, ultraviolet light inhibitors, smoke suppressants, flame retardant, etc. may also or alternatively be incorporated in the thermoplastic material, to enhance specific properties of the sheeting and/or ribs of the present invention. The amount of filler additives may be optimized for a given application or desired property, but typically may vary, for example, between about 0.01 wt. % and about 50 wt. %, or between about 0.1 wt. % and about 25 wt. %, or between about 1 wt. % and about 10 wt. %, or between about 1.5 wt. % and 3 wt. %. For example, in one embodiment, the board comprises about 6 wt. % talc as a filler additive.

B. Process of Preparation

Generally speaking, the thermoplastic polymer board of the present invention may be prepared using techniques generally known in the art. More particularly, however, the board is prepared using an integrated coextrusion technique further detailed herein below, as opposed to, for example, common processes using lamination and/or gluing.

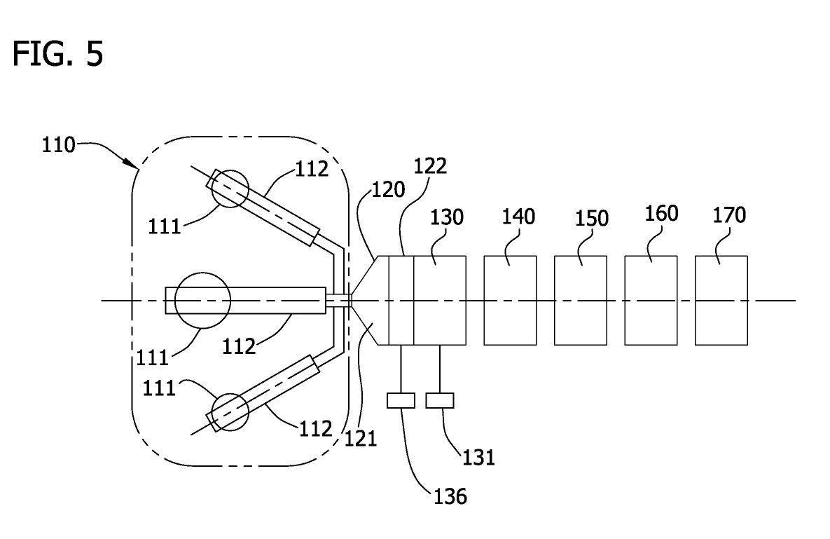

Referring now to FIG. 5, illustrated therein is an apparatus that may be used in the process for manufacturing the boards of the present invention. The apparatus includes an extrusion assembly (110), a die assembly (120), a sizer and cooling assembly (130), a haul-off unit (140), an annealing unit (150), a surface treatment unit (160), and an apparatus for cutting the boards (170). The extrusion assembly may include one or multiple extruders (112). Each extruder contains hoppers (111) which receive solid thermoplastic pellets or powders and other compositions that are directed into the barrel of a screw-type feeder where heat from the friction force or a heater transforms the thermoplastic material into a molten or plastic state. In an integrated, coextrusion process, the feeders typically move the thermoplastic material simultaneously from each feeding section toward the die assembly (120) and forces the thermoplastic material through the die assembly (120) to form boards of desired structure (e.g., a board comprising a first sheet, a second sheet, or a top and bottom sheet, and a core section of some desired configuration therebetween). The molten extruded sheeting then travels directly from the die lip (122) to the sizer and cooling assembly (130), which cools and sets the shape and dimension of the sheeting.

The sheeting exiting from the sizer and cooling assembly (130) passes between and is engaged by pairs of pulling rolls of the haul-off unit (140) which deliver the sheeting through the annealing unit (150), the surface treatment unit (160) and the cutting device (170). The annealing unit (150) contains a heating oven to release induced stress and ensure flatness of the board. The surface treatment unit (160) enhances the affinity of the surfaces of the thermoplastic sheeting to, for example, printing ink, adhesives, etc., in order to have good bonding, while the cutting apparatus (170) cuts the sheeting into its final dimension.

Suitable apparatus for plastifying and extruding the thermoplastic materials are known in the art. Generally, the plastifying and extruding steps can be carried out in an apparatus such as a screw extruder (112). Single or multiple extruders can be used in the extrusion assembly. In the configuration of multiple extruders, different compositions can be used for respective extruders. Therefore, the first planar sheet (2), the second planar sheet (3) and the core comprising the extending ribs (4) of a thermoplastic board (1) can perform respective functions or features.

The thermoplastic resin and additives of suitable proportions are charged into the hoppers (111) of the extruders (112) and plastified within the cavities of extruders at temperatures above the fusion temperatures of the thermoplastic polymers. The plastified and melted thermoplastic masses are then extruded through a die head (121) and die lip (122) at the end of the extruders (112) to form sheeting consisting of a pair of layers spaced apart and interconnected by extending ribs.

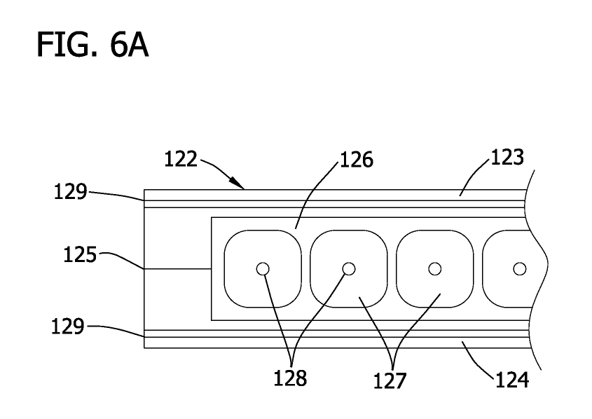

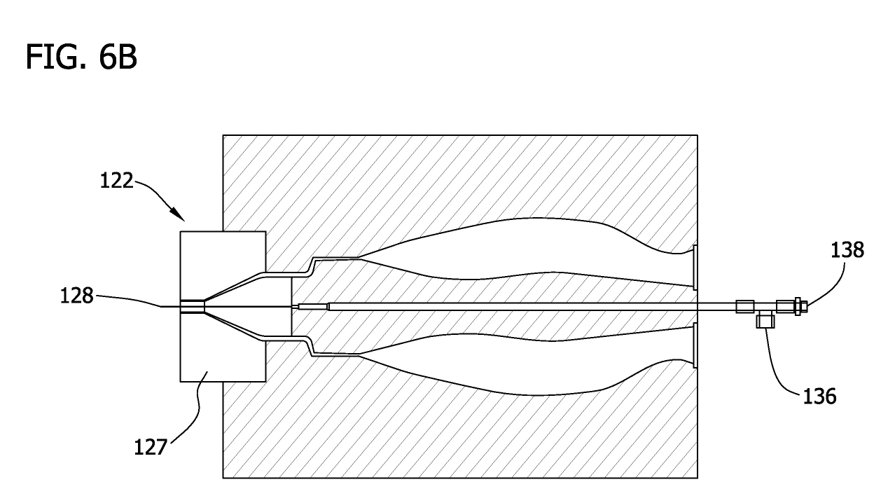

Referring now to FIGS. 6A and 6B, the die lip (122) contains upper and lower die sections (123), (124), each having an electrical heater (129). Die sections (123) and (124) are secured in face-to-face relation along line (125) to form die cavity (126). The cross-section of cavity (126) corresponds to the external shape of board (1). Die sections (123), (124) are provided with cutouts, which receive mandrels (127). The mandrels are connected to a transverse mandrel holder, which secures and positions the mandrel (127) across cavity (120). Longitudinal bores (128) in mandrels (127) are connected to a transverse bore in the mandrel holder which extends transversely through the mandrel holder and communicates with venting facilities which provides air flow (138) through passageways of the board (1) during extrusion.

As detailed elsewhere herein, in order to avoid a potentially detrimental build-up of internal back-pressure within the board, and more specifically the passage ways within the board created by the ribs, cause for example by the cutting process (the act of cutting creating a blockage in the air passageways), the die may preferably be fitted with a pressure release valve (136) of some kind connected, for example, by way of the transverse bore to the longitudinal bores (128) in mandrels (127) or in another manner to the die assembly, in order to allow any pressure which builds up inside the board to be released, thus avoiding fracture or bursting of the board during cutting. Although the valve and die design may vary, generally speaking, the die and valve will be designed based on considerations and techniques generally known in the art, including for example the maximum internal pressure the board will withstand before fracture or bursting occurs, the maximum pressure the equipment that is used in the extrusion process will withstand, etc.

After the die section, the molten thermoplastic sheeting travels directly from the die lip (122) to the sizer and cooling assembly (130). The sizer and cooling assembly (130) contains top and bottom platens, which are provided with a plurality of narrow slots, which communicate with manifolds and are perpendicular to the moving direction of the thermoplastic sheeting. The manifolds are connected to a vacuum source (131), so that the reduced pressure within the manifolds cause extrusion layers (2) and (3) of the thermoplastic sheeting to be forced against the two platen surfaces, respectively, thereby preventing collapse of layers (2) and (3) during the period when layers (2) and (3) and the core comprising the ribs (4) are in a plastic or semi-plastic state and set the final dimension of the thermoplastic boards. As further detailed herein below, direct feeding from the die lip (122) to the sizer and cooling assembly (130) may further help prevent collapse of the layers (2) and (3), because the time the thermoplastic material has to cool, as the board exits the die and enters the sizer and cooling assembly (130), is reduced.

As the board moves from the die lip, the temperature may be between about 150° C. and about 240° C. Accordingly, cooling tubes are embedded behind the surfaces of the upper and lower platen surfaces to cool the board. Cooling water is circulated in the cooling tubes to cool the surface of the thermoplastic sheeting. The cooling water is regularly controlled at a temperature from about 1° C. to about 30° C., such as about 5° C. to about 25° C. The sizer and cooling assembly (130) cools and sets the dimension of the thermoplastic sheeting. The continuously extruded sheeting is then pulled away from the sizer and cooling assembly (130) by a haul-off unit (140).

The thermoplastic sheeting is in a soft and molten state when it leaves the die lip (122) and starts to solidify after entering the sizer and cooling assembly (130). The surfaces of the planar sheets (2) and (3), which are forced against the two platen surfaces, are quenched and rapidly solidified. The thermoplastic materials in the plurality of the extending ribs (4) and beneath the surfaces of the planar sheets (2) and (3) are slowly cooled, since the thermoplastic material is a poor heat conductor.

It is to be noted that when the thermoplastic material is cooled, it shrinks. In general, and without being held to a particular theory, this shrinkage is believed to be due to thermal contraction, and is especially significant for thermoplastic material of high crystallinity in which a portion of the thermoplastic material crystallizes to form a compact crystalline structure from amorphous molten state when the temperature of the thermoplastic material drops below the crystallization temperature of the material. More specifically, this shrinkage is believed to occur because, in order to move through the small slots of the die assembly, the molecules of polymers (i.e., thermoplastic materials) are stretched. Due to the viscoelastic property of the polymeric material, these molecules tend to shrink back to their most stable states when they have passed the die lip, resulting in the shrinkage or necking of the boards. This phenomenon is more significant for the production of the lighter weight boards of the present invention, since the polymeric molecules need to pass the slots of the die assembly with faster speed (e.g., lighter weight boards are prepared using pulling speeds that are faster than for heavier boards). In addition, the thermal contraction of the rib material in the cooling process amplifies this problem.

In accordance with the production process of the board of the present invention, the two outer sheets, upon exiting the die/die lip, are grabbed by the sizer and cooling assembly, in order to provide a board having a consistent thickness and surface smoothness. If this does not consistently or uniformly occur, the surface of the boards may be wavy or uneven, thus limiting the commercial value of the boards. Due to the polymeric properties noted above, and/or the gauge (i.e., length or height) of the ribs of the board of the present invention, the impact of the shrinkage, or necking, when it starts, may be sufficient to overcome the vacuum force of the sizer and cooling assembly. If this occurs, the sizer and cooling assembly cannot grab, and/or hold onto, the surfaces of the sheets, in order to form an acceptable product; that is, the vacuum may be lost, thus ultimately leading to loss of the board. Additionally, as the thickness of the board increases, it may be even more difficult to reduce the weight of the thick boards (i.e., a board having a thickness greater than about 15 mm), since the shrinkage or necking phenomenon may increase as the board thickness increases. To resolve this problem, and thus to reduce the weight of the board and board thickness increases, the gap between the die lip and sizer and cooling assembly may be removed (as further detailed elsewhere herein). As a result, the vacuum force of the sizer and cooling assembly may grab the surfaces of the two outer sheets before the occurrence or onset of the shrinkage or necking.

To illustrate the challenges created by shrinking of the cooling board, it is to be noted that a board 16 mm thick and 106″ wide, prepared by a conventional process, may have a decrease in width by about 3.5% and a decrease in thickness of about 6.5%, about 8.5%, or even about 12.5%; that is, in comparing the width and/or thickness of the board upon exiting the die (120) and just prior to entering the sizer and cooling assembly (130), the width and/or thickness in a conventional process may decrease by the noted amount. Accordingly, in the method of the present invention, wherein the board moves directly from the die lip to the sizer and cooling assembly (130) (i.e., there is no gap or space between the die lip and the sizer and cooling assembly), the shrinkage of the width of the board is reduced to less than about 3% comparing the width of the board after extrusion to the width of the board after cooling. Preferably, the degree of shrinking as measuring by the width of the board is less than about 2%, more preferably less than about 1%, even more preferably less than about 0.5%. Similarly, the degree of shrinking as measure by the thickness of the board is less than about 5%, about 4%, about 3%, about 2%, or even about 1%. For example, for a 16 mm thick and 106″ wide board in which the cooling rate is controlled according to the method of the present invention, the width of the board may shrink by as little as about 0.25%.

As noted above, the sheeting is pulled outwardly from the sizer and cooling assembly (130) at a constant speed by a haul-off unit (140). The haul-off unit is similar to the conventional pulling means in the extrusion of sheeting, such as those employing a plurality of groups of wheels having a resilient cover or those employing friction belts imposed on the top and bottom surfaces of the sheeting. The engaging surfaces, such as resilient covering or belt, have an adjustable gap between the surfaces, therefore, can be adapted to accommodate to the respective thickness of the sheeting.

The thermoplastic board is quenched from molten state in the sizer and cooling assembly (130). Stress is created during the quenching process, especially for crystalline polymers. To release the induced stress, the thermoplastic sheeting is annealed in an oven (150). The annealing process enhances flatness of the thermoplastic sheeting.

After the thermoplastic sheeting has left the annealing unit (150), the surfaces of the thermoplastic sheeting are surface treated in the surface treatment unit (160) with methods such as corona discharge, flaming, etc. The surface treatment removes dust, grease, oils, processing aids, etc. from the surfaces. In addition, the surface treatment forms carbon-carbon double bonds, carbonyl, and hydroxyl groups on the surfaces of the thermoplastic boards to increase the surface energy. As a result, the surface wettability is enhanced to provide a good substrate with good bonding to printing ink, glues, etc.

The sheeting then enters an apparatus for cutting the boards (170), which may employ any means known in the art, such as for example a saw, a knife, a slitter, or the like, and is cut at desired length. In a manner well known in the art, the knife or blade of the cutting apparatus moves at the same speed as that of the sheeting during the period when the knife or blade performs the cutting step. It is to be noted, however, that because of the increased thicknesses of the boards of the present invention, the cutting process typically lasts longer than the cutting process of thinner boards. Accordingly, the knife or blade may, as it cuts through the thermoplastic, cause a back pressure to buildup within the flutes (5), referring to FIG. 1. The back pressure may, in some instances, be so strong as to cause board deformation or may even burst holes through the exterior surfaces of the boards. Accordingly, the system or equipment used may be fitted with a pressure release of some kind, using means and/or equipment generally known in the art. For example, referring now to FIGS. 5 and 6B, in one embodiment, the die tool may be equipped with a pressure release valve (136).

Generally speaking, the cutting implements may be any saw, knife, or slitter known in the art which is sufficient to make a relatively clean cut through the thick boards of the present invention. However, in one embodiment, the cutting implement for cutting the thick boards is a heated knife. The temperature of the heated knife is in part dictated by the material from which the board is constructed. Typically, however, for the thermoplastic materials noted herein, the temperature is greater than about 130° C. and less than about 250° C. For example, for a polypropylene board, the knife may be heated to a temperature between about 165° C. and about 210° C. For a polyethylene board, the knife may be heated to a temperature between about 140° C. and about 200° C.

C. Additional Board Properties

In addition to the properties noted above, the thermoplastic board of the present invention is advantageous due to the flat crush resistance, the edge crush resistance, the flexural strength, and/or flexural deflection resistance, etc. the board exhibits. For example, the board may have a flat crush resistance, as measured using the TAPPI-825 test method known in the art, of greater than about 250 psi (pounds per square inch), about 500 psi, about 750 psi or even about 1000 psi, this resistance for example ranging from about 350 to about 950 psi, or about 500 psi to about 750 psi. Additionally, or alternatively, the board may have an edge crush strength resistance, as measured using the TAPPI-810 test method known in the art, of greater than about 200 psi, about 250 psi, about 275 psi, or more. Additionally, or alternatively, the board may have a flexural strength, as measured using ASTM-D790 text method known in the art, of greater than about 500 lbf (pound force) in the machine direction (MD) or flute direction, or about 600, about 700, about 800, about 900, or even about 1000 lbf. Additionally, or alternatively, the board may have a flexural deflection resistance, as measured using ASTM-D790 text method known in the art, of greater than about 1000 lbf/in in MD, or about 1100, about 1200, about 1300, about 1400, or even about 1500 lbf/in. Additionally, or alternatively, the board may have a sustained pressure loading, as measured using ASTM E1996 wind zone 4 test, of at least about 50 lbf/ft², about 60 lbf/ft², about 70 lbf/ft², about 80 lbf/ft², about 90 lbf/ft², about 100 lbf/ft², up to about 105 lbf/ft².

The following Examples further illustrate the present invention. More specifically, in accordance with the present invention, 5 boards were prepared (Formulas A-E) and tested. The details of the board compositions, test methods, and test results are provided below.

### EXAMPLES

### Example 1

### Thermoplastic Board of Formula A

In Formula A, the composition of the planar sheets and the core layer comprising the ribs was the same. Boards constructed according to Formula A comprised the following materials and wt. % of each material:

Polypropylene: 94 wt. %; and,

Talc: 6 wt. %.

The polypropylene was Formolene® PP, commercially available from Formosa Plastics Corporation, USA.

Boards using the above-noted formula were prepared having varying thicknesses (as detailed in Table 1, under Example 6, below) in accordance with the process as provided in U.S. Pat. No. 5,658,644, the entire contents of which is incorporated herein by reference. More specifically, the board was prepared using a conventional extrusion technique, the extrusion temperature being maintained within the range of between 170° C. and 210° C., and the extrusion die temperature being maintained within the range of between 200° C. and 220° C. After exiting the die, the board was vacuum shaped and cooled at a temperature of about 20° C.

### Example 2

### Thermoplastic Board of Formula B

In Formula B, the composition of the planar sheets and the core layer comprising the ribs was the same. Boards constructed according to Formula B comprised the following materials and wt. % of each material:

Polypropylene: 88 wt. %;

Polyethylene: 6 wt. %; and,

Talc: 6 wt. %.

The polypropylene was Formolene® PP, commercially available from Formosa Plastics Corporation, USA. The polyethylene in this and other examples is Formolene® PE available from Formosa Plastics Corporation, USA. The board was prepared as set forth in Example 1, above.

### Example 3

### Thermoplastic Board of Formula C

In Formula C, the composition of the planar sheets and the core layer comprising the ribs was the same. Boards constructed according to Formula C comprised the following materials and wt. % of each material:

Polypropylene: 87 wt. %;

Polyethylene: 6 wt. %;

Foaming agent: 1 wt. %; and,

Talc: 6 wt. %.

The polypropylene was Formolene® PP, commercially available from Formosa Plastics Corporation, USA. The polyethylene in this and other examples is Formolene® PE available from Formosa Plastics Corporation, USA. The board was prepared as set forth in Example 1, above.

### Example 4

### Thermoplastic Board of Formula D

In Formula D, the composition of the planar sheets and the composition of the core layer comprising the ribs differed. A planar sheet constructed according to Formula D comprised the following materials and wt. % of each material:

Polypropylene: 94 wt. %; and,

Talc: 6 wt. %.

A core layer comprising the ribs constructed according to Formula D comprised the following materials and wt. % of each material:

Polypropylene: 80%; and,

Elastic Polymer: 20%.

The elastic polymer is an elastic polyethylene polymer sold under the trade name AFFINITY™ available from Dow Chemical. The polypropylene was Formolene® PP, commercially available from Formosa Plastics Corporation, USA. The polyethylene in this and other examples is Formolene® PE available from Formosa Plastics Corporation, USA. The board was prepared as set forth in Example 1, above.

### Example 5

### Thermoplastic Board of Formula E

In Formula E, the composition of the planar sheets and the composition of the core layer comprising the ribs differed. A planar sheet constructed according to Formula E comprised the following materials and wt. % of each material:

Polypropylene: 94 wt. %; and,

Talc: 6 wt. %.

A core layer comprising the ribs constructed according to Formula E comprised the following materials and wt. % of each material:

Polypropylene: 99 wt. %; and,

Foaming Agent: 1 wt. %.

The polypropylene was Formolene® PP, commercially available from Formosa Plastics Corporation, USA. The board was prepared as set forth in Example 1, above.

### Example 6

### Performance Testing of Thermoplastic Boards of Examples 1 THROUGH 5

Thermoplastic boards having compositions according to Formulae A-E described above in Examples 1-5, respectively were subjected to laboratory tests measuring strength, flat crush resistance, edge crush resistance, and other performance characteristics.

The boards were constructed to a variety of nominal thicknesses. The test boards had nominal and actual thicknesses (in mm) and base weights (in g/m²) as shown in the following Table I.

TABLE I
Thickness and Base Weight

| | | Nominal | Actual | Base Weight |
|---|---|---|---|---|
| Board # | Formula | Thickness(mm) | Thickness (mm) | (g/m²) |
| 1 | A | 16 | 16.08 | 3300 |
| 2 | A | 16 | 16.03 | 4170 |
| 3 | D | 16 | 15.93 | 3580 |
| 4 | E | 16 | 16.08 | 3620 |
| 5 | A | 17 | 17.09 | 4650 |
| 6 | A | 17 | 17.36 | 5460 |
| 7 | B | 19 | 18.95 | 3770 |
| 8 | C | 19 | 18.67 | 3960 |

Thermoplastic boards #1-8 were subjected to a variety of performance tests according to standard testing procedures. Additionally, conventional thinner boards (having thicknesses of 10 mm and 13 mm) and thick corrugated paper (25 mm thickness) were also tested according to the standard testing procedures. The results of the tests are shown in Table II below:

TABLE II
Performance Testing of Thermoplastic Boards

| | | | | Flexural | | Flexural |
|---|---|---|---|---|---|---|
| | | | Flexural | Deflection | Flexural | Deflection |
| | | | Strength³ | Resistance³ | Strength³ | Resistance³ |
| | FCR¹ | ECR² | in MD⁵, | in MD⁵, | in TD⁶, | in TD⁶, |
| Board | (psi) | (psi) | lbf | lbf/in | lbf | lbf/in |
| 1 | 521 | >276 | 555 | 990 | — | — |
| 2 | 918 | >276 | 673 | 1170 | 152 | 285 |
| 3 | 353 | >276 | — | — | — | — |
| 4 | 460 | >276 | — | — | — | — |
| 5 | 847 | >276 | 814 | 1450 | 227 | 417 |
| 6 | 983 | >276 | 885 | 1590 | 337 | 620 |
| 7 | 272 | >276 | 642 | 1390 | 151 | 254 |
| 8 | 355 | >276 | 512 | 1070 | 134 | 262 |
| 10 mm | 140 | 80 | 184 | 232 | 67 | 90 |
| 13 mm | 282 | 114 | 348 | 507 | 112 | 126 |
| 25 mm | — | — | 209 | 1040 | 150 | 877 |
| paper⁴ | | | | | | |

¹FCR: flat crush resistance, tested according to TAPPI-825
²ECR: edge crush resistance, tested according to TAPPI-810
³All flexural measurements tested according to ASTM D790
⁴25 mm paper is 25 mm corrugated paper
⁵MD: machine direction or flute direction, in pounds of force (lbf) or pounds of force per inch.
⁶TD: transverse direction or cross flute direction, in pounds of force (lbf) or pounds of force per inch.

According to the performance test results shown in Table II, overall, the thermoplastic boards of the present invention exhibited enhanced crush resistance and strength compared to the thinner boards, while still being relatively light weight for their thicknesses. Additionally, the thermoplastic boards exhibited strength comparable to or better than the 25 mm thick corrugated paper, even though the thermoplastic boards were thinner and lighter than the corrugated paper.

In view of the above, it may be seen that the several objects of the invention are achieved and other advantageous results attained.

When introducing elements of the present invention or the preferred embodiment(s) thereof, the articles “a”, “an”, “the” and “said” are intended to mean that there are one or more of the elements, notwithstanding that the term “at least one” and the like are used herein. The terms “comprising,” “including,” and “having” are intended to be inclusive and mean that there may be additional elements other than the listed elements.

What is claimed is:

1. A process for the preparation of a thermoplastic polyolefin board, the process comprising:
extruding a thermoplastic polyolefin resin through a die to form a board comprising (i) a first planar sheet having an outwardly facing surface and an inwardly facing surface, (ii) a second planar sheet having a outwardly facing surface and an inwardly facing surface, said first and second planar sheets being disposed in about parallel spaced relationship to each other, and (iii) a plurality of ribs extending between the first and second planar sheets, each of said ribs having connecting points to said inwardly facing surfaces of said first planar sheet and said second planar sheet, and forming, in combination with said sheets, a plurality of elongated lateral passageways;
injecting air into passageways in the extruded board, as said passageways are formed;
vacuum shaping and cooling the extruded thermoplastic board; and
cutting the cooled board into sections of desired length, wherein said board has a thickness, as measured by a distance between the first outwardly facing surface and the second outwardly facing surface, of at least about 15 mm.

2. The process of claim 1, wherein the board is vacuum shaped and cooled so that the thickness of the extruded board decreases by less than about 5%, as determined by comparing the thickness of the board immediately after extrusion to the thickness of the board after cooling.

3. The process of claim 1, wherein the board is vacuum shaped and cooled so that the width of the extruded board decreases by less than about 3%, as determined by comparing the width of the board after extrusion to the width of the board after cooling.

4. The process of claim 1, wherein the board is cut into sections using a heated knife.

5. The process of claim 4, wherein the knife is heated to a temperature between about 140° C. and about 210° C.

6. The process of claim 1, wherein the die is equipped with a pressure release valve.

7. The process of claim 1, wherein the board has a weight of at least about 2,000 g/m².

8. The process of claim 1, wherein the board has a weight no greater than about 12,000 g/m².

9. The process of claim 1, wherein the board has a weight between about 3,000 g/m² and about 8,000 g/m².

10. The process of claim 1, wherein the board can sustain a loading pressure of at least about 50 lb/ft².

11. The process of claim 10, wherein the board comprises at least about 95 wt. % of the thermoplastic polyolefin resin.

12. The process of claim 10, wherein the board has a thickness of at least about 20 mm.

13. The process of claim 1, wherein the board can sustain a loading pressure of at least about 70 lb/ft².

14. The process of claim 13, wherein the board comprises at least about 95 wt. % of the thermoplastic polyolefin resin.

15. The process of claim 13, wherein the board has a thickness of at least about 20 mm.

16. The process of claim 1, wherein the board can sustain a loading pressure of at least about 90 lb/ft².

17. The process of claim 16, wherein the board comprises at least about 95 wt. % of the thermoplastic polyolefin resin.

18. The process of claim 16, wherein the board has a thickness of at least about 20 mm.

19. The process of claim 1, wherein the thermoplastic polyolefin resin is selected from the group consisting of polypropylene, polyethylene, a copolymer of polypropylene and polyethylene, and combinations thereof.

20. The process of claim 1, wherein the board passes the ASTM E1996 wind zone 4 test.
